(19) United States
(12) Patent Application Publication
(10) Pub. No.: US 2015/0360196 A1
(43) Pub. Date: Dec. 17, 2015

(54) Control System for Gas Production

(71) Applicant: MAGNEGAS CORPORATION, Tarpon Springs, FL (US)

(72) Inventors: Christopher Lynch, Largo, FL (US); Mike Rodriguez, Safety Harbor, FL (US)

(21) Appl. No.: 14/737,819

(22) Filed: Jun. 12, 2015

Related U.S. Application Data
(60) Provisional application No. 62/012,013, filed on Jun. 13, 2014.

(51) Int. Cl. B01J 19/08

(52) U.S. Cl. CPC B01J 19/088; B01J 2219/0801; B01J 2219/0809; B01J 2219/0816; B01J 2219/0871; B01J 2219/0877; B01J 2219/0894

(57) ABSTRACT

A system for producing a gas includes a reactor (pressure vessel) containing in its interior a feedstock and a set of electrodes. A computer is operatively interfaced to a power supply, the power supply providing power to the electrodes. Software stored in a non-transitory storage that is accessed by the computer, runs on the computer and accepts operator control commands. Responsive to the operator control commands, the software instructs the computer to control the power supply and form an electric arc between electrodes. The software controls a pump to flow the feedstock through a plasma of the electric arc. The electric arc converts at least some of the feedstock into a gas. The gas is collected for later use. The software reads a level sensor that is interfaced to the reactor. When the level sensor indicates a feedstock level is low, the software initiates flow of additional feedstock into the reactor by way of controlling a second pump.

### CROSS-REFERENCE TO RELATED APPLICATION

This application claims the benefit of U.S. provisional application No. 62/012,013 filed on Jun. 13, 2014, the disclosure of which are incorporated by reference.

### FIELD

This invention relates to the field of gas production and more particularly to a system, method and apparatus for controlling the production of an arc-produced gas here within referred to as Magnegas.

### BACKGROUND

It has been demonstrated that, by exposing and/or flowing certain fluids through the plasma of a submerged electric arc, a unique gas is produced. The composition of the produced gas is dependent upon the feedstock in use and the materials of the arc, but the family of gases produced by exposing and/or flowing certain fluids through the plasma of an electric arc are herein referred to as Magnegas®. Various types and sources of feedstock have been used to produce Magnegas®. The resulting gas burns clean and at higher temperatures than gases occurring in nature or gases produced in different ways.

In general, the feedstock is presented into a reaction chamber, in which a submerged electric arc is formed between electrodes. As the feedstock is exposed to the arc, the arc releases gases from the feedstock which are captured and stored for future uses.

In various systems, different methods have been anticipated to form the arc, control the electrodes, replenish/replacing the electrodes, capture the gas, capture heat produced, etc. Examples of fully operational systems for the production of Magnegas® can be found in U.S. Pat. No. 7,780,924 issued Aug. 24, 2010, U.S. Pat. No. 6,183,604 issued Feb. 6, 2001, U.S. Pat. No. 6,540,966 issued Apr. 1, 2003, U.S. Pat. No. 6,972,118 issued Dec. 6, 2005, U.S. Pat. No. 6,673,322 issued Jan. 6, 2004, U.S. Pat. No. 6,663,752 issued Dec. 16, 2003, U.S. Pat. No. 6,926,872 issued Aug. 9, 2005, and U.S. Pat. No. 8,236,150 issued Aug. 7, 2012, all of which are incorporated by reference.

In many of the systems for generation of Magnegas®, the reactor (or chamber) is filled with the feedstock and then the feedstock if pumped into and/or around the plasma of the arc, producing the gas which is then collected. As time goes by, as portions of the feedstock change into gas, dissolved and/or suspended particles within the feedstock change the properties of the feedstock. For example, consider flowing salt water through such an arc over a period of time. As the water (H₂O) is transformed into hydrogen (H) and Oxygen (O₂), the salt content of the remaining salt water increases. If such a process is allowed to continue, eventually the only material left in the reactor will be salt, though before that point, a very viscous liquid containing small amounts of water and large amounts of salts will be present.

Likewise, in examples where the feedstock is, for example, used vegetable oils (e.g. oils previously used to cook food), as the vegetable oils transform into Magnegas®, dissolved and/or suspended particles within the feedstock remain, again changing the properties of the feedstock such as increasing the viscosity of the feedstock and/or changing the electrical conductance of the feedstock.

Over time, temperatures of the reactor vary, the condition of the electrodes change, etc., all needing monitoring and control.

What is needed is a system that monitors gas production, feedstock volume and properties, temperature, etc., and instantaneously effects the operating parameters of the reactor to compensate for changes and variances and to provide maximum efficiencies.

### SUMMARY

In a first embodiment, a system for producing a gas includes a reactor containing in its interior a feedstock and a set of electrodes. The system has a controller for controlling the electrodes, operatively forming an electric arc between the electrodes. There is a mechanism for passing the feedstock through a plasma of the electric arc thereby converting at least some of the feedstock into a gas and a mechanism for collecting the gas. Further, there is a mechanism for introducing additional feedstock into the reactor, under control of the controller.

In another embodiment, a system for producing a gas includes a reactor containing in its interior a feedstock and a set of electrodes. A computer is operatively interfaced to a power supply, the power supply providing power to the electrodes. Software stored in a non-transitory storage that is accessed by the computer, runs on the computer and accepts operator control commands. Responsive to the operator control commands, the software instructs the computer to control the power supply and form an electric arc between electrodes. The software controls a pump to flow the feedstock through a plasma of the electric arc. The electric arc converts at least some of the feedstock into a gas. The gas is collected for later use. The software reads a level sensor that is interfaced to the reactor. When the level sensor indicates a feedstock level is low, the software initiates flow of additional feedstock into the reactor by way of controlling a second pump.

In another embodiment, a system for producing a gas includes a reactor containing in its interior a feedstock and a set of electrodes. The system also has a computer that is electrically interfaced to the set of electrodes. Software stored in a non-transitory storage that is accessed by the computer accepts operator control commands and responsive to the operator control commands, the software instructs the computer to operatively form an arc between electrodes of the set of electrodes. The software controls a pump to flow the feedstock through a plasma of the arc, the arc thereby converting at least some of the feedstock into a gas. The gas is collected for later use. The software reads a viscosity of the feedstock through a sensor that is interfaced to the reactor and to the computer. The software initiates operation of a second pump to inject a material into the reactor responsive to the software determining that the viscosity of the feedstock is greater than a pre-determined viscosity. The material is selected from the group consisting of additional feedstock, a solvent, tap water, and distilled water.

In another embodiment, a system for producing a gas includes a pressure vessel containing in its interior a feedstock and at least one set of electrodes in which an electric arc is formed between the electrodes. The system includes a mechanism for passing of the feedstock through a plasma of the electric arc thereby converting at least some of the feedstock into a gas (e.g., a circulation system). The system has a way to controlling the electric arc by, for example, a controller adjusting the position of the electrodes of the arc and/or voltage applied to those electrodes. The system collects the gas (e.g. moves the gas to a storage tank). During the production of the gas, the system measures at least one of a conductance of the feedstock and a viscosity of the feedstock and, based on this/these measurements, the system introduces a material into the pressure vessel such as fresh feedstock, a solvent, tap water, distilled water, etc.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of an exemplary system for producing gas.

FIG. 2 illustrates a second schematic view of the exemplary system for producing gas.

FIG. 3 illustrates a third schematic view of the exemplary system for producing gas.

FIG. 4 illustrates a fourth schematic view of the exemplary system for producing gas.

FIG. 5 illustrates a schematic for power distribution of the exemplary system for producing gas.

FIG. 6 illustrates a schematic for electrical connection of the exemplary system for producing gas.

FIG. 7 illustrates a second schematic for electrical connection of the exemplary system for producing gas.

FIG. 8 illustrates a third schematic for electrical connection of the exemplary system for producing gas.

FIG. 9 illustrates a circuit board and connections for the controller of the exemplary system for producing gas.

FIG. 10 illustrates a schematic view of gas distribution within the exemplary system for producing gas.

FIG. 11 illustrates a schematic view of user interface of the exemplary system for producing gas.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

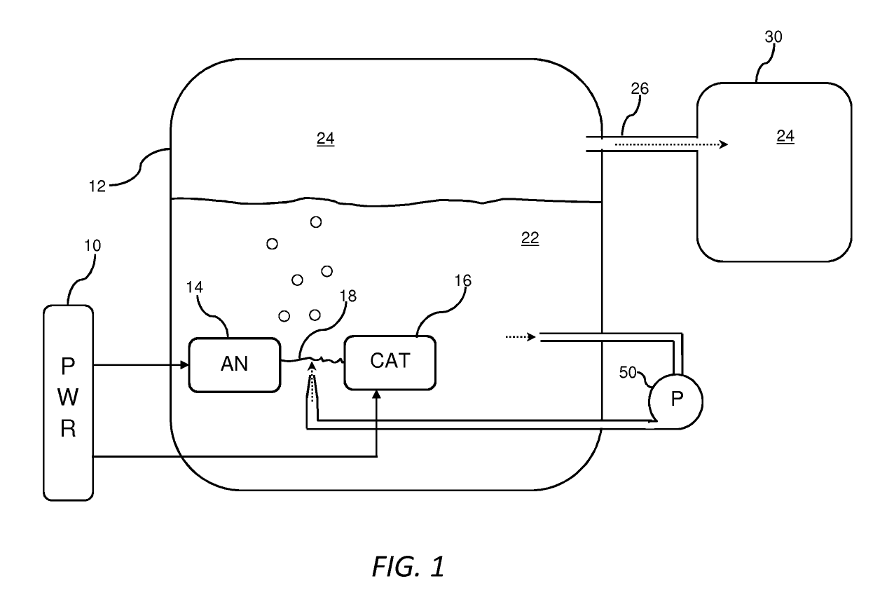

Referring to FIG. 1, an exemplary system for the production of a combustible fluid herein called Magnegas, which is typically in gaseous form as used herein. This is but an example of one system for the production of Magnegas, as other such systems are also anticipated. Examples of fully operational systems for the production of Magnegas can be found in U.S. Pat. No. 7,780,924 issued Aug. 24, 2010, U.S. Pat. No. 6,183,604 issued Feb. 6, 2001, U.S. Pat. No. 6,540,966 issued Apr. 1, 2003, U.S. Pat. No. 6,972,118 issued Dec. 6, 2005, U.S. Pat. No. 6,673,322 issued Jan. 6, 2004, U.S. Pat. No. 6,663,752 issued Dec. 16, 2003, U.S. Pat. No. 6,926,872 issued Aug. 9, 2005, and U.S. Pat. No. 8,236,150 issued Aug. 7, 2012, all of which are incorporated by reference.

As exemplified in FIGS. 1-4, the production of such a fluid (e.g. Magnegas) is performed within the plasma 18 of a submerged electric arc formed by providing an electrical potential between an anode 14 and a cathode 16 that are of sufficient proximity to each other as to allow arcing between the anode 14 and the cathode 16. An appropriate power supply 10 provides sufficient power (voltage and current) as to initiate and maintain the arc.

A feedstock 22 is circulated within a tank 12 by, for example, a pump 50 and the feedstock 22 is injected into the plasma 18 of the electric arc formed between two electrodes 14/16, causing the feedstock 22 to react, depending upon the composition of the feedstock 22 and the composition of the electrodes 14/16 used to create the arc. One exemplary feedstock 22 is oil, and more particularly, used vegetable or animal oil such as that from deep-fat fryers, etc. Of course, any oil is anticipated, including unused vegetable oil and oil from animal fat.

Any feedstock 22 is anticipated either in fluid form or a fluid mixed with solids, preferably fine-grain solids such as carbon dust, etc.

In one example, the feedstock 22 is vegetable oil and the electrodes 14/16 are carbon, the vegetable oil molecules separate within the plasma 18 of the electric arc forming a gas 24 referred to here-within as Magnegas 24, typically including hydrogen (H₂) and carbon monoxide (CO) atoms, which percolate to the surface of the feedstock 22 for collection (e.g. extracted through a collection pipe 26) and stored in a collection tank 30. This gas 24 (e.g. Magnegas) is similar to synthetic natural gas or syngas, but the gas produced though this process behaves differently and produces a higher temperature burn. In embodiments in which at least one of the electrodes 14/16 that form the arc 18 is made from carbon, such electrode(s) 14/16 serve as a source of charged carbon particles (e.g. carbon nanoparticles) that become suspended within the gas 24 and are collected along with the gas 24, thereby changing the burning properties of the resulting gas 24.

In examples in which the feedstock 22 is a petroleum-based liquid, the exposure of this petroleum-based feedstock 22 to the plasma 18 results in production of a gas that includes polycyclic aromatic hydrocarbons which, in some embodiments, are quasi-nanoparticles that are not stable and, therefore, some of the polycyclic aromatic hydrocarbons will form/join to become nanoparticles or a liquid. Therefore, some polycyclic aromatic hydrocarbons as well as some carbon particles/nanoparticles are present in the resulting gas 24. In some embodiments, some of the carbon particles or nanoparticles are trapped or enclosed in poly cyclic bonds. Analysis of the produced gas 24 typically shows inclusion of polycyclic aromatic hydrocarbons that range from C6 to C14. The presence of polycyclic aromatic hydrocarbons as well as carbon particles or nanoparticles contributes to the unique burn properties of the resulting gas 24. This leads to higher burning temperatures.

In another example, when the feedstock 22 is petroleum based (e.g. used motor oil) and at least one of the electrodes 14/16 is/are carbon, the petroleum molecules separate within the plasma 18 of the electric arc into a gas 24 that includes hydrogen (H₂) and aromatic hydrocarbons, which percolate to the surface of the petroleum liquid 22 for collection (e.g. extracted through a collection pipe 26) and stored in a collection tank 30. In some embodiments, the gas 24 (Magnegas) produced though this process includes suspended carbon particles since at least one of the electrodes of the arc 18 is made from carbon and serves as the source for the charged carbon particles or nanoparticles that travel with the manufactured hydrogen and aromatic hydrocarbon gas 24 and are collected along with, for example, the hydrogen and aromatic hydrocarbon molecules, thereby changing the burning properties of the resulting gas 24, leading to a hotter flame. In this example, if the feedstock 22 is oil (e.g. used oil) and the fluid/gas 24 collected includes any or all of the following: hydrogen, ethylene, ethane, methane, acetylene, and other combustible gases to a lesser extent, plus suspended charged carbon particles or nanoparticles that travel with these gases.

In another example, when the feedstock 22 is water based (e.g. sewerage or waste water) the water molecules separate within the plasma 18 of the electric arc into a gas 24 that includes hydrogen (H₂), which percolate to the surface of the feedstock 22 for collection (e.g. extracted through a collection pipe 26) and stored in a collection tank 30. In some embodiments, the gas 24 (Magnegas) produced though this process includes suspended carbon particles since at least one of the electrodes of the arc 18 is made from carbon and serves as the source for the charged carbon particles or nanoparticles that travel with the produced gas 24 and are collected along with, for example, the hydrogen molecules, thereby changing the burning properties of the resulting gas 24, leading to a hotter flame.

The resulting gas is stored in, for example, a tank 30 and moved/distributed as known in the gaseous/liquid fuel industry.

In the example shown in FIG. 1, a circulation pump 50 runs continuously, flowing the feedstock 22 through the plasma 18 of the arc formed between the electrodes 14/16. In such, manual adjustment of the arc, power, and refilling of the feedstock are performed.

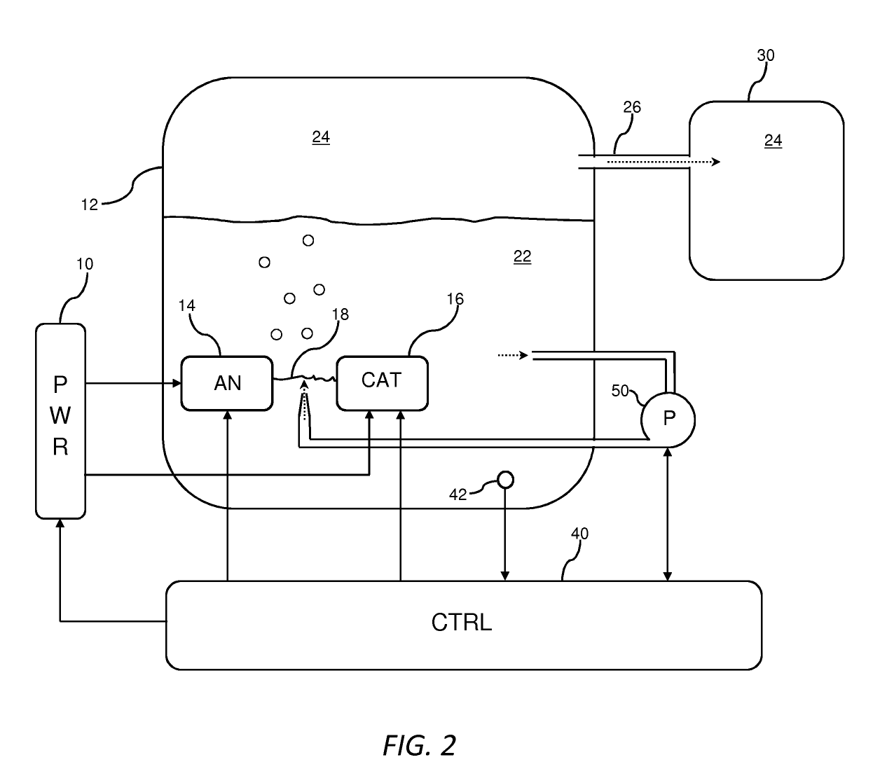

In the example shown in FIG. 2, the circulation pump 50, the power supply, and/or the electrodes 14/16 are controlled by a control system 40, typically a computer-based controller. The control system 40 monitors the performance of the arc, controlling the voltage applied to the arc by the power supply 10, moving the anode 14 and/or cathode 16 closer to each other or farther away from each other to adjust the resulting plasma 18, cycling the electrodes 14/16 as one or both electrodes erode due to the arc, and adjusting speed of the circulation pump 50 and, therefore, flow rate through the plasma 18.

For example, as some types of feedstock 22 are transformed into the gas 24, the remaining feedstock 22 becomes more viscous, especially when impurities are suspended in the feedstock. One example of such is used motor oil. As the viscosity of the feedstock 22 increases due to higher concentrations of, for example, fine metal particles, it takes more work for the circulation pump 50 to maintain the same flow rate through the plasma 18. In some embodiments, the load of the circulation pump motor is measured, which will correlate the viscosity of the feedstock 22 being pumped. As the load of the motor increases, the control system 40 increases power to the circulation pump 50 to maintain a certain level of flow, for example, a constant flow rate. In other embodiments, a viscosity sensor 42 provides a signal to the control system 40, informing the control system 40 of the current viscosity of the feedstock 22 and the control system 40 adjusts the pump speed to compensate for the measured viscosity. At some point, the measured viscosity exceeds a pre-determined level and the control system 40 indicates such to an operator for stopping, cleaning, and/or refilling the system. Any known viscosity sensor 42 is anticipated for use in this application.

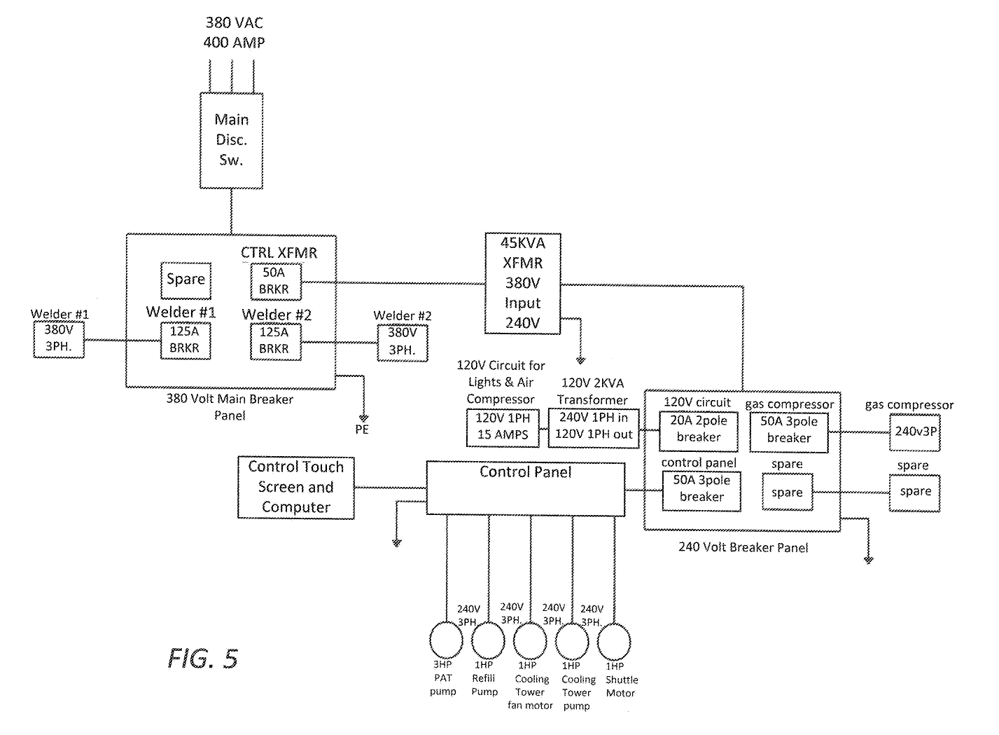

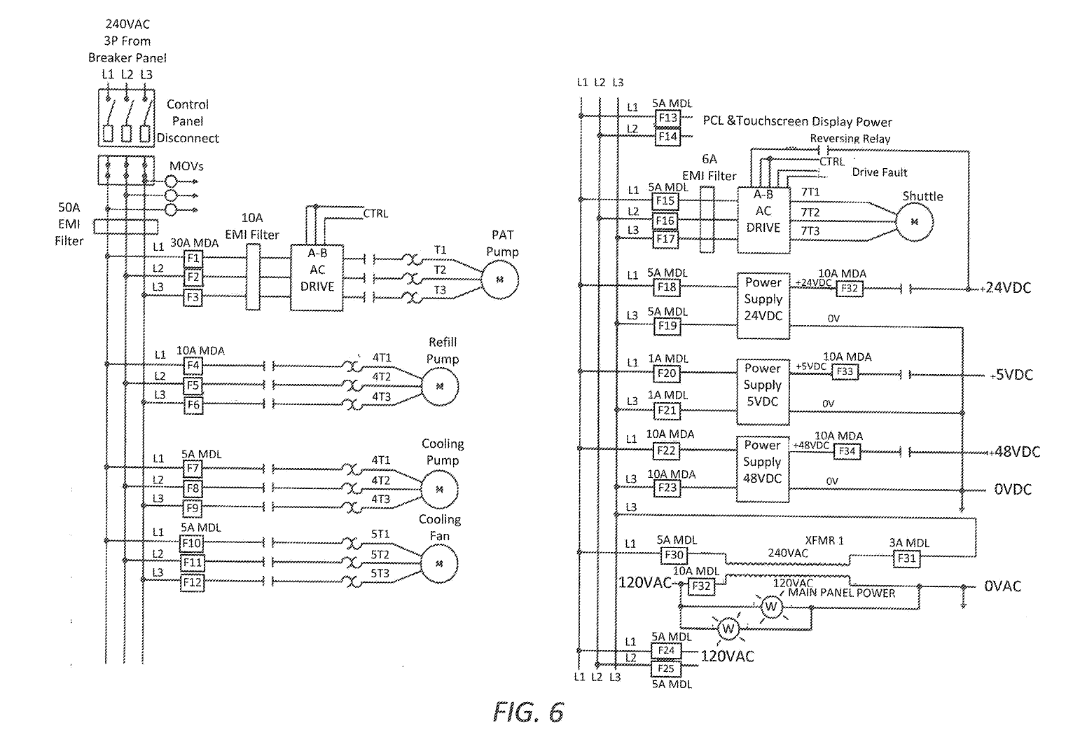

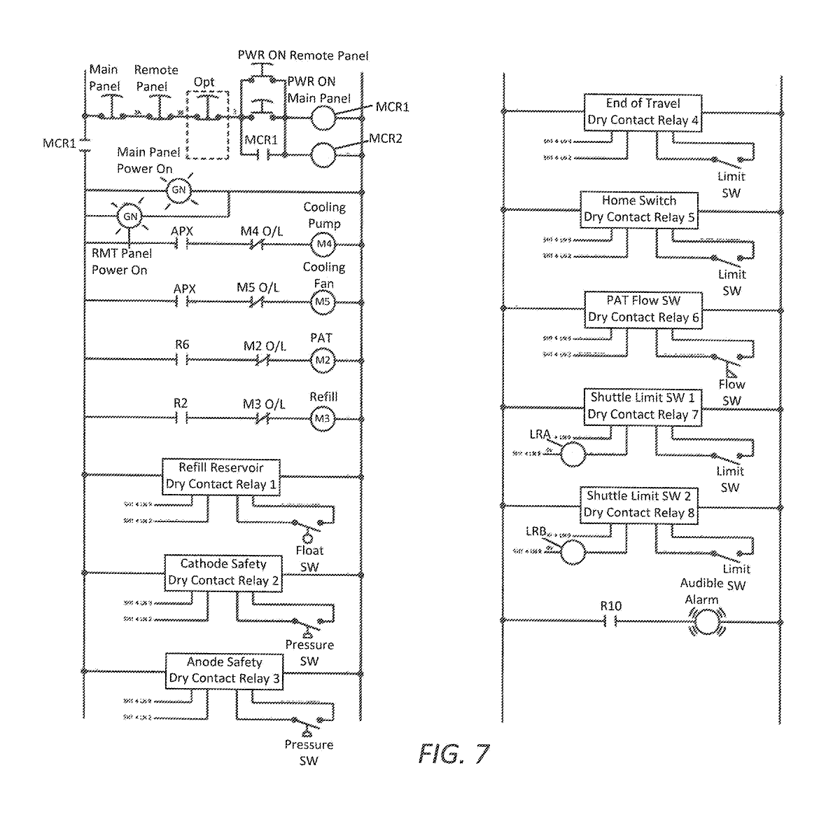

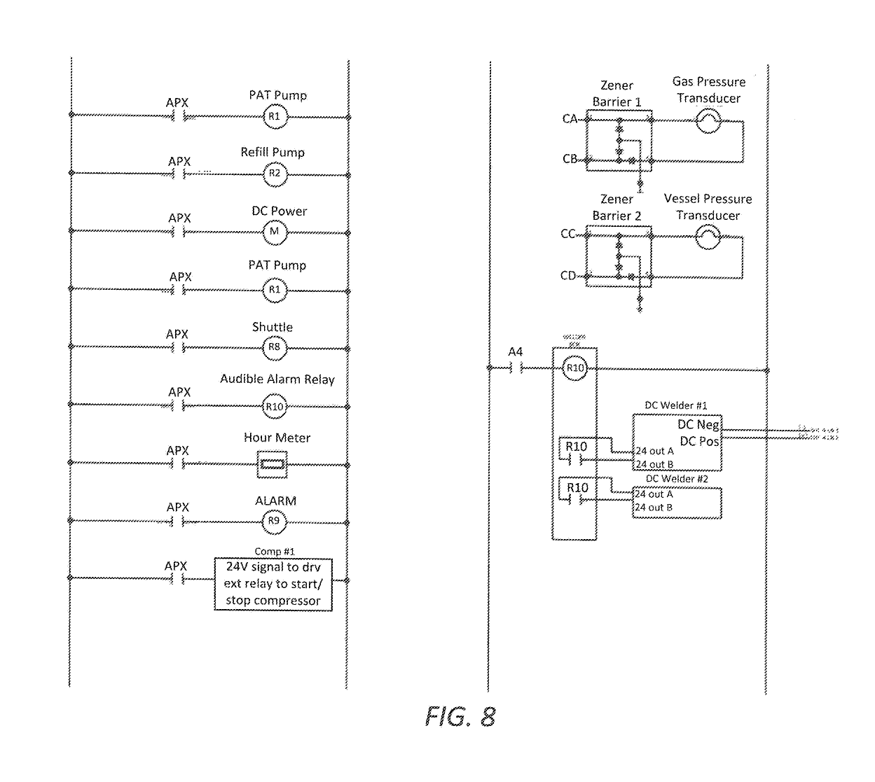

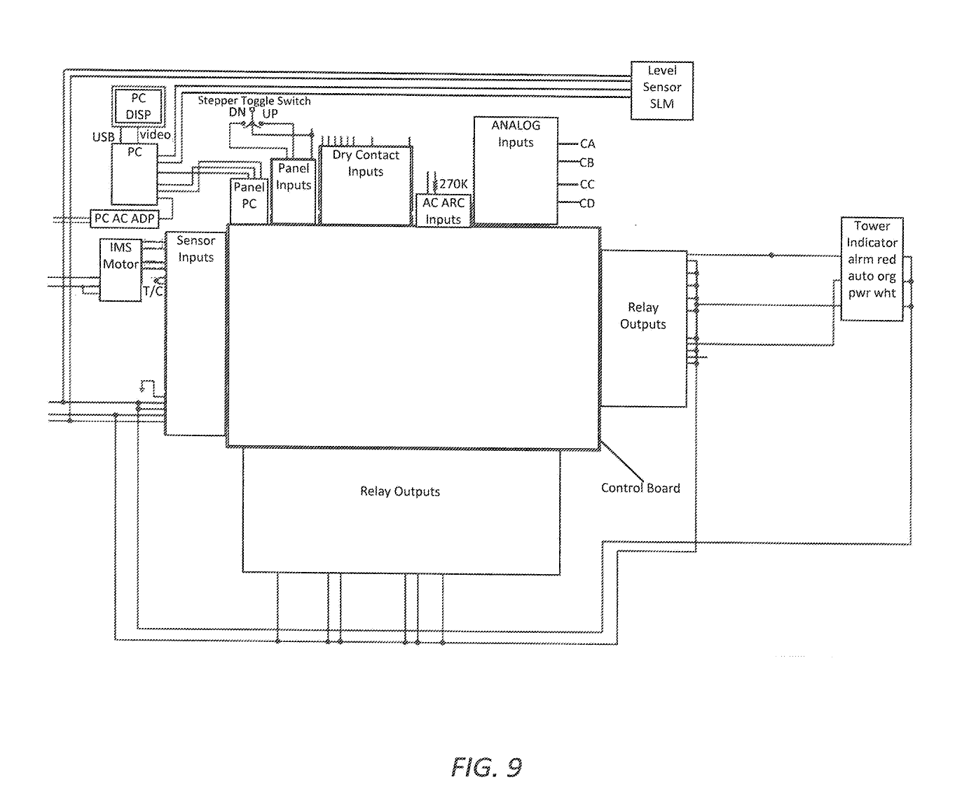

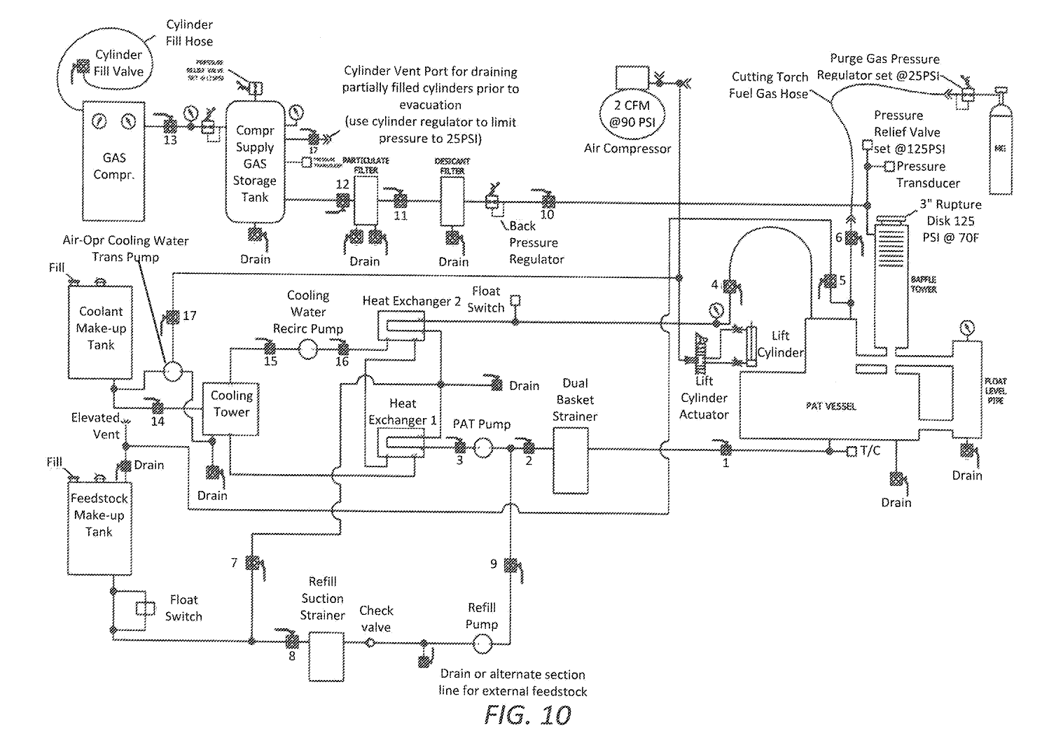

FIGS. 5-10 show and disclose an exemplary control system. The System has three modes of operation; “Gasification”, “Sterilization”, “Total-Linear” and “Batch” the following sections describes the functionality and system functionality for these modes of operation.

Gasification mode gasifies the target feedstock 22 for the maximum conversion of the liquid feedstock 22 to gas and is most suitable for oily or hazardous wastes feedstock 22 that require elimination and/or neutralization. This mode is a closed loop system where the feedstock 22 is repeatedly circulated through the reactor 12 to create the gas 24, heat, and residual carbonized solids.

In this mode, the feedstock 22 is pumped through the reactor 12 where the arc creates a plasma 18 within the feedstock 22 and converts the liquid feedstock 22 molecules into a gas 24. The feedstock 22 then flows through the heat exchangers which cools the fluid prior to returning to the arc chamber. As the feedstock volume decreases following conversion in the reactor 12, the control system automatically replenishes the level from a raw feedstock storage tank.

During the process the gas 24 rises to the surface in the reactor 22 and is transferred for collection in the storage tank 30 prior to, for example, being compressed and bottled in the high pressure cylinders.

The residual solids byproducts produced during this process are collected by the various strainers and filters located in the system.

In the Sterilization Mode a process that sterilizes a feedstock 22 such as sewage or agricultural wastes is performed. Any effluent is anticipated for the feedstock 22, where eliminating bacteriological activity is beneficial to treat the feedstock 22 prior to releasing into the environment. This result of the process is again, the gas 24, carbon precipitates, and “sterilized” liquid. This mode consists in passing the feedstock 22 through the plasma arc one, single time.

Additional equipment such as belt presses, automated filters, and a centrifuge may be added for the removal of carbonized substances in suspension. It is also anticipated that the filtered liquid feedstock 22 be passed through one or more sand filters to remove the suspended solids, perhaps down to the micron level.

Following the sand filters, in some embodiments, a carbon filter is added for the removal of the remaining contaminants.

To assure complete sterilization, in some embodiments, an Ultraviolet (UV) Station is added to complete the sterilization process of the feedstock 22. This mode results in the gas 24 and sterilized feedstock 22.

The Total-Linear mode is essentially similar to the Sterilization mode with partial recirculation. This means that the feedstock 22 is passed through the plasma arc several times. Certain liquid wastes, such as; city sludge, dairy liquid wastes, leather processing liquid waste, and others liquid bio-waste materials, contain a high percentage of water trapped in the colloidal lattice structure of the feedstock 22. This condition prevents the efficient use of the sterilization mode and does not allow the initial filtration of biomasses. In this case, it is desired to first to break down the lattice structure via the Gasification mode followed by the sterilization mode for final processing.

In the Total-Linear Mode, feedstock 22 is pumped into the reactor 12 with the option of being passed through a macerator to reduce the size of the particulates in the feedstock 22. Next the feedstock 22 enters the recirculation pump and is passed through the plasma arc 18 in the reactor 12. Depending on the flow rate and the type of the feedstock 22 being processed, the feedstock 22 passes through the arc multiple times.

After passing through the reactor 12, the feedstock 22 passes through heat exchangers to cool the feedstock 22 prior to exiting the system as a treated fluid.

Typically in this mode, the reactor 12 is filled with the liquid feedstock 22 and the system is initially operated in the gasification mode until the feedstock 22 reaches a temperature of approximately 1750 F, at that point the system mode is switched to sterilization and the temperature is held constant over the boiling value of the feedstock 22.

The process results in gas 24 production and sterilized feedstock 22.

Referring to FIGS. 5-11, the exemplary controller 40 includes a System Control Computer such as a standard industrial PC running a standard operating system. The computer preferably has a touch screen panel and USB ports for keyboards, trackballs, or mice, etc.

The computer is capable of remote operation over the internet via, for example, a standard Ethernet port located on computer.

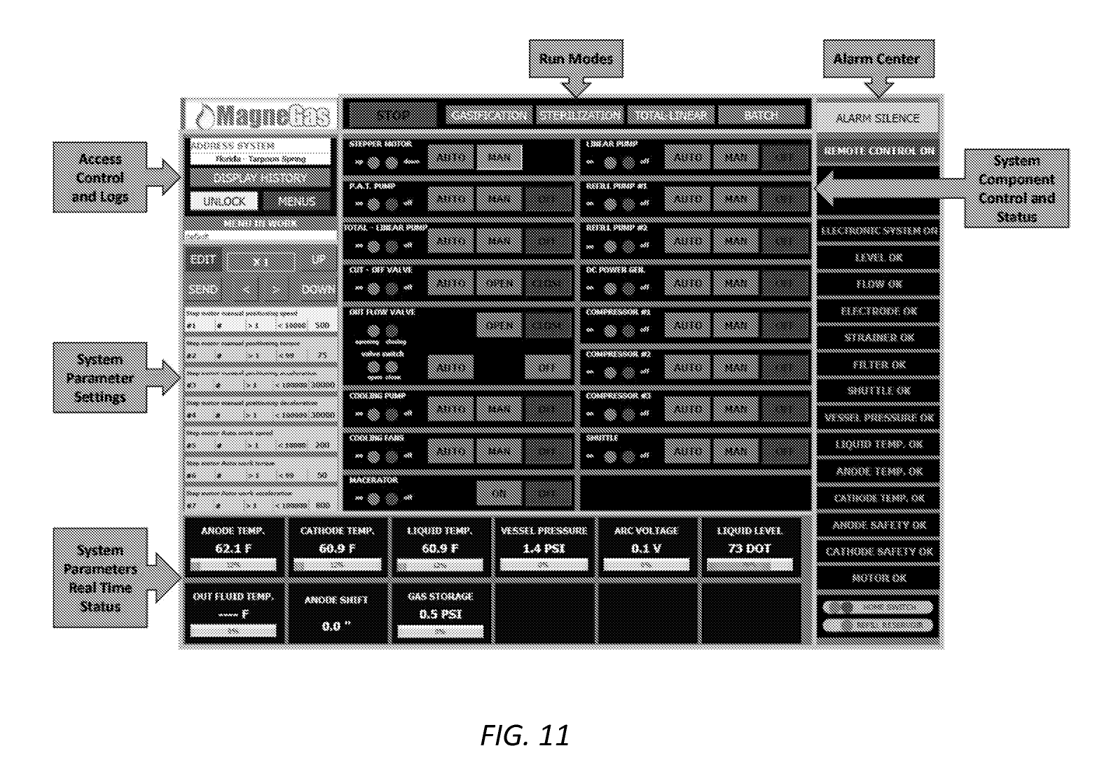

A sample system control user interface is shown in FIG. 11.

System capabilities include Run Modes selected by the operator display. “STOP”—Implements a systematic shut-down of the system. “GASIFICATION”—Starts and runs the system in the GASIFICATION mode. “STERILATION”—Starts and runs the system in the STERILIZATION mode. “TOTAL-LINEAR”—Starts and runs the system in the TOTAL-LINEAR mode. “BATCH”—Starts and runs the system in “Gasification” mode for the designated period.

Various alarms signal abnormal conditions by visual and/or audible indication of the health of system and its components while operating.

“ALARM STATUS”—Indicates the overall status of the system and provides the ability to silence the audible alarm.

“REMOTE CONTROL”—Identifies whether the system is being controlled locally or remotely.

“ELECTRONIC SYSTEM ON/OFF”—Indicates the on/off state or the Electronic System.

“LEVEL”—Fluid level in the PAT Vessel is outside of system parameter settings.

“FLOW”—Indicates no or little Feedstock flow in the system.

“ELECTRODE”—Anode “End of Travel” limit switch has been activated.

“STRAINER”—Strainer is not operating correctly.

“FILTER”—Filter is not operating correctly.

“SHUTTLE”—Cathode Shuttle Motor is not operating correctly.

“VESSEL PRESSURE”—PAT Vessel pressure is in excess of the system parameter setting.

“LIQUID TEMP.”—Feedstock temperature is in excess of the system parameter setting.

“ANODE TEMP.”—Anode temperature is in excess or the system parameter setting.

“CATHODE TEMP.”—Cathode temperature is in excess of the system parameter setting.

“ANODE SAFETY”—Anode Safety Tube Pressure Switch has been activated.

“CATHODE SAFETY”—Cathode Safety Tube Pressure Switch has been activated.

“MOTOR”—Anode Stepper Motor is not operating correctly. “HOME SWITCH”—Indicates if the Anode is or is not in the “Home Position”.

“REFILL RESERVOIR”—Indicates if the Feedstock level in the Refill Reservoir is OK or low.

Control of the individual system components is provided as well as an indication of the individual component operational states.
“STEPPER MOTOR”—Controls the position of the Anode.
Control of the stepper motor is either:
“AUTO” (automatic) which is based on the selected Run Mode and System Parameter Setting or
“MAN” (Manual). While in the manual mode the Stepper Motor can be controlled from the Stepper Motor. The “up” and “down” indicators identify the direction the Stepper Motor is moving the Anode.
“P.A.T PUMP”—Controls the flow of the fluid through the reactor 12. Control of the pump is either “AUTO” (automatic) which is based on system parameter settings or “MAN” (manual control). The “MAN” selection will manually turn on/off the pump. The “on” and “off” indicators identify the pump state.
“TOTAL-LINEAR PUMP”—The Total-Linear Pump, pumps feedstock 22 into the system and located after the optional macerator in systems capable of Total-Linear mode. Control of the pump is either “AUTO” (automatic) which is based on system parameter setting or “MAN” (manual control). The “MAN” selection will turn on/off the pump. The “on” and “off” indicators identify the pump state.
“CUT-OFF VALVE”—The Cut-Off valve opens or closes the out flow of processed fluid from the system. Control of the valve is either “AUTO” (automatic) which is based on system parameter settings or “OPEN”/“CLOSED (manual operation). The “on” and “off” indicators identify the valve state.
“OUT-FLOW VALVE”—The Out-Flow valve is a variable flow valve that maintains the pressure in the reactor 12. Control of the valve is either “AUTO” (automatic) which is based on system parameter settings or “OPEN”/“CLOSED (manual operation). The “opening”, “closing”, on”, and “off” indicators identify the valve state.
“COOLING PUMP”—The Cooling Pump recirculates the cooling liquid between the Cooling Tower and the Heat Exchangers. Control of the pump is either “AUTO” (automatic) which is based on the system parameter setting or “MAN” (manual control). The “MAN” selection will turn on/off the pump. The “on”, “off”, and “OFF” indicators identify the pump state.
“COOLING FANS”—The Cooling Fans are located in the Cooling Tower. Control of the fans is either “AUTO” (automatic) which is based on system parameter setting or “MAN” (manual control). The “MAN” selection will turn on/off the fans. The “on”, “off”, and “OFF” indicators identify the pump state.
“MACERATOR”—The Macerator is used to grind up large particulates in the Feedstock 22 prior to entering the reactor 12. Control of the macerator pump is manual “ON” or “OFF”. The “on” and “off” indicators identify the pump state.
“LINEAR PUMP”—The Linear Pump (also called the Sterilization Pump) pumps Feedstock into the system in systems capable of Total-Linear mode. Control of the pump is either “AUTO” (automatic) which is based on system parameter settings or “MAN” (manual control). The “MAN” selection will turn on/off the pump. The “on”, “off”, and “OFF” indicators identify the pump state.
“REFILL PUMP #1”—The Refill Pump #1 (also called the Gasification Pump) adds raw Feedstock 22 into the reactor 12. Control of the pump is either “AUTO” (automatic) which is based on system parameter settings or “MAN” (manual control). The “MAN” selection will turn on/off the pump. The “on”, “off”, and “OFF” indicators identify the pump state.
“REFILL PUMP #2”—The Refill Pump #2 (also called the Total-Linear Pump) adds raw Feedstock 22 into the reactor 12. Control of the pump is either “AUTO” (automatic) which is based on system parameter settings or “MAN” (manual control). The “MAN” selection will turn on/off the pump. The “on”, “off”, and “OFF” indicators identify the pump state.
“DC POWER GEN.”—The DC Power Generator is the DC Power Source to the electrodes. Control of the DC Power Source is either “AUTO” (automatic) which is based on system parameter settings or “MAN” (manual control). The “MAN” selection will turn on/off the generator. The “on”, “off”, and “OFF” indicators identify the generator state.
“COMPRESSOR #1”—The Compressor transfers and compresses the gas 24 stored in the Compressor Storage Tank into the high pressure cylinders. Control of the Compressor is either “AUTO” (automatic) which is based on system parameter setting or “MAN” (manual control). The “MAN” selection will turn on/off the compressor. The “on”, “off”, and “OFF” indicators identify the Compressor state.
“COMPRESSOR #2”—Control of the Compressor is either “AUTO” (automatic) which is based on system parameter settings or “MAN” (manual control). The “MAN” selection will turn on/off the compressor. The “on”, “off”, and “OFF” indicators identify the Compressor state.
“COMPRESSOR #3”—Control of the Compressor is either “AUTO” (automatic) which is based on system parameter settings or “MAN” (manual control). The “MAN” selection will turn on/off the Compressor. The “on”, “off”, and “OFF” indicators identify the Compressor state.
“SHUTTLE”—The Shuttle Motor moves the Cathode electrode horizontally within the reactor 12. Control of the Shuttle is either “AUTO” (automatic) which is based on system parameter settings or “MAN” (manual control). The “MAN” selection will turn on/off the motor. The “on”, “off”, and “OFF” indicators identify the motor state.

In this exemplary control system, display information provides real-time status of key system parameters in the system. The bar under each readout gives the measurement percentage relative to the System Parameter Settings.
“ANODE TEMP.”—Temperature of Anode electrode, degrees F.
“CATHODE TEMP.”—Temperature of Cathode electrode, degrees F.
“LIQUID TEMP.”—Temperature of Feedstock 22 within the reactor 12, degrees F.
“VESSEL PRESSURE”—Pressure within the reactor 12, Pounds per Square Inch (PSI).
“ARC VOLTAGE.”—DC Power Source output voltage to electrodes, volts DC.
“LIQUID LEVEL.”—Level of the Feedstock 22 within the reactor 12, DOTs (LED light bar level).
“OUT FLUID TEMP.”—Temperature of the feedstock 22 after the Heat Exchangers, degrees F.
“ANODE SHIFT”—Number of inches the Anode is shifted from the “Home” position and indicates the amount of anode electrode consumption, inches.
“GAS STORAGE”—Pressure in the gas 24 Compressor Storage Tank, Pounds per Square Inch (PSI).

System parameter settings are made through the controller. Function description of exemplary parameters, range for each parameter, defaults settings, editing process and associated warnings follow.

“EDIT”—Enables the editing of the system parameters. To enable editing the operator enters the system password. This is also the function is which the system password is administered.

“SEND”—Sends the changed parameters to the system.

“X1”, “X10”, and “X100”—Multiplier for system parameters being edited. “<” and “>”—Left and right scrolling through system parameter fields. “UP” and “DOWN”—Up and down scrolling through the system parameters list. Typical parameters follow below.

TABLE 1
System Parameters

| | | | Min | Max | Default |
|---|---|---|---|---|---|
| # | Parameter | Description | Value | Value | Value |
| 1 | Step motor manual | Controls the speed of the | 1 | 10000 | 500 |
| | positioning speed | step motor while in | | | |
| | | manual mode | | | |
| 2 | Step motor manual | Controls the torque of the | 1 | 99 | 75 |
| | positioning torque | step motor while in | | | |
| | | manual mode | | | |
| 3 | Step motor manual | Controls the acceleration | 1 | 1000000 | 30000 |
| | positioning | of the step motor while in | | | |
| | acceleration | manual mode | | | |
| 4 | Step motor manual | Controls the deceleration | 1 | 1000000 | 30000 |
| | positioning | of the step motor while in | | | |
| | deceleration | manual mode | | | |
| 5 | Step motor Auto | Controls the speed of the | 1 | 10000 | 200 |
| | work speed | step motor while in auto | | | |
| | | mode | | | |
| 6 | Step motor Auto | Controls the speed of the | 1 | 99 | 50 |
| | work torque | step motor while in auto | | | |
| | | mode | | | |
| 7 | Step motor Auto | Controls the acceleration | 1 | 1000000 | 800 |
| | work acceleration | of the step motor while in | | | |
| | | auto mode | | | |
| 8 | Step motor Auto | Controls the deceleration | 1 | 1000000 | 800 |
| | work deceleration | of the step motor while in | | | |
| | | auto mode | | | |
| 9 | Displacement ratio | Set mechanical | 1 | 10000 | 2500 |
| | | displacement ratio, | | | |
| | | corrected value = | | | |
| | | reduction ratio × spindle | | | |
| | | pitch) | | | |
| 12 | Work Arc Voltage | Target DC voltage applied | 1.0 | 100.0 | 37.0 |
| | | to electrodes, volts | | | |
| 13 | Stabilization Max | Work Arc Voltage | 1 | 100 | 3 |
| | tolerance | maximum variation, % | | | |
| 14 | Optimization delay | Time delay in DC voltage | 0 | 100 | 0 |
| | (0 = no Optimization) | optimization, 0 is | | | |
| | | inhibited, seconds | | | |
| 15 | Arc not present | Maximum voltage setting | 1.0 | 100.0 | 41.0 |
| | threshold | considered as “Arc | | | |
| | | Present”, volts | | | |
| 18 | Integration Time | Maximum integration | 10 | 225 | 10 |
| | | time to measure voltage | | | |
| | | dips, msec. | | | |
| 20 | Step motor | Rotational direction of the | 0 | 1 | 0 |
| | direction of rotation | step motor (0 = clockwise, | | | |
| | | 1 = counter clockwise) | | | |

TABLE 2
System Patameters

| | | | Min | Max | Default |
|---|---|---|---|---|---|
| # | Parameter | Description | Value | Value | Value |
| 22 | Short circuit | Anode - Cathode short | 0 | 99.9 | 20.0 |
| | threshold | circuit condition, volts | | | |
| 24 | Arc voltage digital | Voltage digital filter | 0 | 255 | 2 |
| | filter | algorithm (high value, | | | |
| | | more filter action), value | | | |
| 25 | End of work | Time delay moving anode | 0 | 99 | 2 |
| | electrode opening | after the system has been | | | |
| | time | stopped, avoids initial | | | |
| | | short circuit on start-up, | | | |
| | | seconds | | | |
| 26 | Max short circuit | Amount of time that short | 0.1 | 99.0 | 7.0 |
| | time | circuit is allowed before | | | |
| | | shutting down Shuttle | | | |
| | | Motor and DC Power | | | |
| | | Source, seconds. | | | |
| 27 | Arc present | Voltage measurement, | 0 | 10000 | 50 |
| | integration time | integration period when | | | |
| | | arc is present, csec. | | | |
| 40 | PAT Pump Turn on | Delay for PAT Pump turn- | 0 | 6000.0 | 0.0 |
| | delay | on, seconds. Set at 0 for | | | |
| | | Gasification. | | | |
| 41 | PAT Pump Turn off | Delay for PAT Pump turn- | 0 | 6000.0 | 3600.0 |
| | delay | off, seconds. | | | |
| 42 | Refill Pump #1 Turn | Delay for Refill Pump #1 | 0 | 6000.0 | 0.0 |
| | on delay | turn-on, seconds. | | | |
| 43 | Refill Pump #1 Turn | Delay for Refill Pump #1 | 0 | 6000.0 | 0.0 |
| | off delay | turn-off, seconds. | | | |
| 44 | Refill Pump #2 Turn | Delay for Refill Pump #2 | 0 | 6000.0 | 0.0 |
| | on delay | turn-on, seconds. | | | |
| 45 | Refill Pump #2 Turn | Delay for Refill Pump #2 | 0 | 6000.0 | 0.0 |
| | off delay | turn-off, seconds. | | | |
| 46 | Linear Pump Turn | Delay for Linear Pump | 0 | 6000.0 | 10.0 |
| | on delay | turn-on, seconds. | | | |
| 47 | Linear Pump Turn | Delay for Linear pump | 0 | 6000.0 | 0.0 |
| | off delay | turn-off, seconds. | | | |
| 48 | Total-Linear Pump | Delay for Total-Linear | 0 | 6000.0 | 10.0 |
| | Turn on delay | Pump turn-on, seconds. | | | |
| 49 | Total-Linear Pump | Delay for Total-Linear | 0 | 6000.0 | 0.0 |
| | Turn off delay | Pump turn-off, second. | | | |
| 50 | Shuttle Turn on | Delay for Shuttle Motor | 0 | 99 | 10 |
| | delay | turn-on after arc is | | | |
| | | present, seconds. | | | |
| 51 | Shuttle Turn off | Delay for Shuttle Motor | 0 | 99 | 0 |
| | delay | turn-off after arc is lost, | | | |
| | | seconds. | | | |
| 60 | Total Linear flow | Total-Linear flow meter | 0 | 10.0 | 5.0 |
| | setpoint | voltage. | | | |
| 61 | Linear flow setpoint | Linear flow meter voltage. | 0 | 10.0 | 5.0 |

TABLE 3
System Patameters

| | | | Min | Max | Default |
|---|---|---|---|---|---|
| # | Parameter | Description | Value | Value | Value |
| 62 | Refill Pump #1 | Refill Pump #1 flow meter | 0 | 10.0 | 5.0 |
| | setpoint | voltage. | | | |
| 63 | Refill Pump #2 | Refill Pump #2 flow meter | 0 | 10.0 | 5.0 |
| | setpoint | voltage. | | | |
| 64 | Linear and Total- | Set point for PAT Vessel | 1 | 96 | 75 |
| | Linear set point | liquid, Dots. | | | |
| 65 | Total MIN level | Minimum level in PAT | 1 | 96 | 40 |
| | | Vessel, causes shutdown, | | | |
| | | Dots. | | | |
| 66 | Total MAX level | Maximum level in PAT | 1 | 96 | 80 |
| | | Vessel, causes shutdown, | | | |
| | | Dots. | | | |
| 70 | Batch Mode Timer | Batch duration in minutes. | 1 | 99 | 15 |
| 80 | Liquid temp cooling | Cooling fan turn-on point | 0 | 500 | 100 |
| | fans START | based on temperature of | | | |
| | threshold | cooling liquid, degrees F. | | | |
| 81 | Liquid temp cooling | Cooling fan turn-off point | 0 | 500 | 80 |
| | fan STOP threshold | based on temperature of | | | |
| | | cooling liquid, degrees F. | | | |
| 82 | Liquid temp cooling | Cooling pump turn-on | 0 | 500 | 100 |
| | pump START | point based on | | | |
| | threshold | temperature of cooling | | | |
| | | liquid, degrees F. | | | |
| 83 | Liquid temp cooling | Cooling fan turn-off point | 0 | 500 | 80 |
| | pump STOP | based on temperature of | | | |
| | threshold | cooling liquid, degrees F. | | | |
| 84 | Liquid temp Alarm | Point where alarm | 0 | 500 | 200 |
| | threshold | triggered, degrees F. | | | |
| 85 | Liquid Temp Stop | Point where the system | 0 | 500 | 230 |
| | threshold | shuts down, degrees F. | | | |
| 86 | Anode temp Alarm | Anode electrode | 0 | 500 | 300 |
| | threshold | temperature, degrees F. | | | |
| 87 | Cathode temp | Cathode electrode | 0 | 500 | 300 |
| | Alarm threshold | temperature, degrees F. | | | |
| 88 | Vessel Pressure | PAT Vessel pressure that | 0 | 160 | 50 |
| | Alarm and Stop | alarms and shuts down | | | |
| | threshold | the system, Pounds per | | | |
| | | Square Inch (PSI). | | | |
| 89 | Compressor #1 | Start point where | 0 | 160 | 12 |
| | START Setpoint | Compressor is turned on | | | |
| | | based on pressure in | | | |
| | | Compressor Supply | | | |
| | | Storage Tank, Pounds per | | | |
| | | Square Inch (PSI). | | | |
| 90 | Compressor #1 | Stop point where | 0 | 160 | 5 |
| | STOP Setpoint | Compressor is turned off | | | |
| | | based on pressure in | | | |
| | | Compressor Supply | | | |
| | | Storage Tank, Pounds per | | | |
| | | Square Inch (PSI). | | | |

TABLE 4
System Patameters

| | | | Value | Value | Value |
|---|---|---|---|---|---|
| 91 | Compressor #2 | Start point where | 0 | 160 | 25 |
| | START Setpoint | Compressor is turned on | | | |
| | | based on pressure in | | | |
| | | Compressor Supply | | | |
| | | Storage Tank, Pounds per | | | |
| | | Square Inch (PSI). | | | |
| 92 | Compressor #2 | Stop point where | 0 | 160 | 15 |
| | STOP Setpoint | Compressor is turned off | | | |
| | | based on pressure in | | | |
| | | Compressor Supply | | | |
| | | Storage Tank, Pounds per | | | |
| | | Square Inch (PSI). | | | |
| 93 | Compressor #3 | Start point where | 0 | 160 | 30 |
| | START Setpoint | Compressor is turned on | | | |
| | | based on pressure in | | | |
| | | Compressor Supply | | | |
| | | Storage Tank, Pounds per | | | |
| | | Square Inch (PSI). | | | |
| 94 | Compressor #3 | Stop point where | 0 | 160 | 20 |
| | STOP Setpoint | Compressor is turned off | | | |
| | | based on pressure in | | | |
| | | Compressor Supply | | | |
| | | Storage Tank, Pounds per | | | |
| | | Square Inch (PSI). | | | |
| 95 | Gas storage max | Maximum pressure | 0 | 160 | 40 |
| | pressure | allowed in Compressor | | | |
| | | Supply Storage Tank | | | |
| | | before system alarms and | | | |
| | | shuts down, Pounds per | | | |
| | | Square Inch (PSI). | | | |

Access Control and Logs—“ADDRESS SYSTEM”—Is a unique address for the system. “DISPLAY HISTORY”—Brings up log file of operational system readings. One output example is a history display.

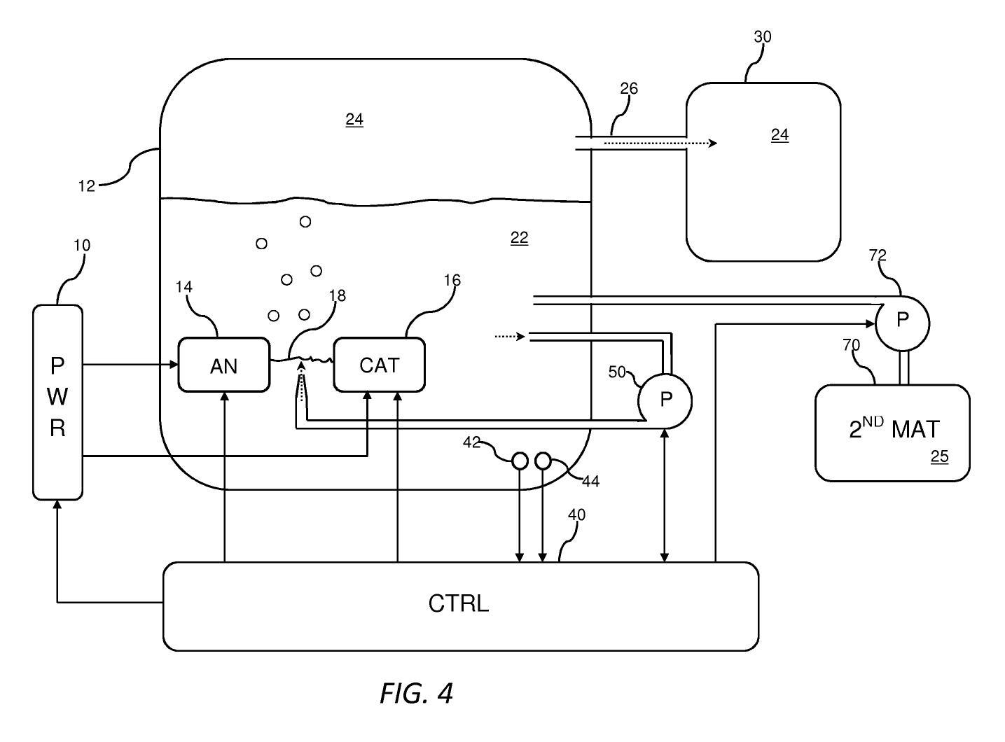

“UNLOCK”—Enables editing of the system parameters or the loading of new parameter Menus (files). Selecting the “UNLOCK” button brings up the display screen shown in FIG. 4-5. Editing of system parameters and files can begin after the correct password is entered. From the Password display the operator can also change the system password. Once the system has been unlocked for editing by entering the correct password, the “UNLOCK” button will change to “LOCK”. Selecting the “LOCK” button will disable all editing functions.

“MENUS”—When the “MENUS” button is selected on the top level control screen, a complete listing of the system parameter are displayed as shown in FIG. 4-6. “RETURN”—This button will return the operator to the main menu. “SEND PARAMETERS”—Selecting this button will send new parameters to the system.

“NEW MENU”—Allows the operator to save new parameters to a new menu (system parameters file).

“MENUS”—Selecting the Menus button will bring up the “LOAD Menu” and a list of stored files containing system parameters, such as the “Test1.” file. After a file has been selected, it can either be loaded with the “LOAD MENU” button or deleted with the “DELETE” button. The “RETURN” button will return to the previous “PARAMETERS MENU” screen. “MENU IN WORK”—Displays the System Parameters file/menu currently in use.

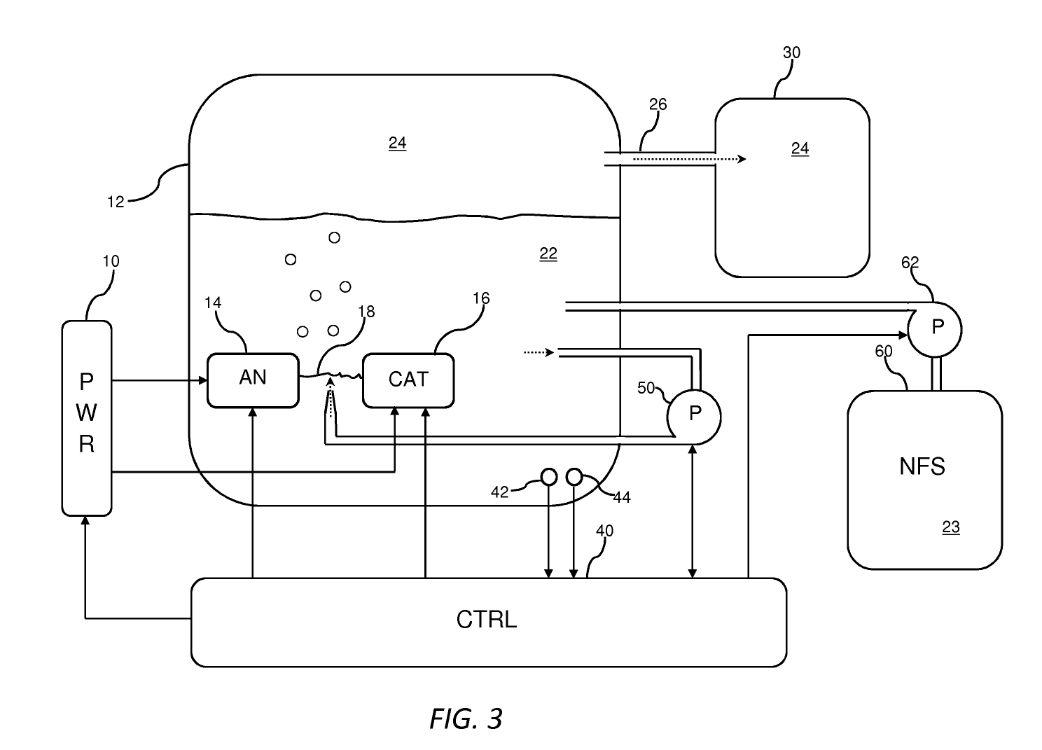

In the example shown in FIG. 3, a replenishment pump 62 and a tank 60 containing new feedstock 23 is included. In this, the circulation pump 50, the power supply 10, the feedstock replenishment pump 62, and/or the electrodes 14/16 are controlled by the control system 40. The control system 40 monitors the performance of the arc, controlling the voltage applied to the arc by the power supply 10, moving the anode 14 and/or cathode 16 closer to each other or farther away from each other to adjust the resulting plasma 18, cycling the electrodes 14/16 as one or both electrodes erode due to the arc, and adjusts the speed of the circulation pump 50 and, therefore, flow rate through the plasma 18. The control system 40 also controls the feedstock replenishment pump 62, signaling the feedstock replenishment pump 62 to pump additional feedstock 22 from a replenishment tank 60 containing additional feedstock 22.

As some types of feedstock 22 are transformed into the gas 24, the remaining feedstock 22 becomes more viscous, especially when impurities are suspended in the feedstock. One example of such is used motor oil, as the oil content is converted to gas 24 by the plasma 18 of the arc, the remaining feedstock 22 (oil) becomes more concentrated with, for example, suspending fine-grain metal particles. As the viscosity of the feedstock 22 increases, it takes more work for the circulation pump 50 to maintain the same flow rate through the plasma 18. In some embodiments, the load of the circulation pump motor is measured, which will correlate the viscosity of the feedstock 22 being pumped. In some embodiments, a viscosity sensor 42 provides a signal to the control system 40, informing the control system 40 of the current viscosity of the feedstock 22. When the control system 40 finds the viscosity to be too high, the control system 40 either adjusts the speed of the circulation pump 50 to compensate for the high viscosity or initiates operation of the feedstock replenishment pump 62 for a specific period of time to further dilute the feedstock 22 within the reactor 12 with new (fresh) feedstock 23 from the replenishment tank 60. In some systems the control system 40 does both, adjusting the pump speed to compensate for the high viscosity and initiating operation of the feedstock replenishment pump 62 to insert a certain amount of fresh feedstock. In some embodiments, the feedstock replenishment pump 62 is operated for a specific period of time or until the measured viscosity lowers to a predetermined level. It is anticipated that various level and pressure sensors are used to make sure that the reactor 12 is not overfilled, etc.

It is also anticipated that, at some point in the operation, the measured viscosity exceeds a pre-determined level and the control system 40 indicates such to an operator for stopping, cleaning, and/or refilling the system.

In this same example, as some types of feedstock 22 are transformed into the gas 24, the conductivity of these feedstocks changes due to certain dissolved or suspended materials concentrating in the remaining feedstock. One example of such is water containing salts. It is known that pure water does not conduct electricity (e.g. distilled water), but as salts are added to this pure water, water with suspended salts now conducts electricity. If the concentration of salts in the feedstock 22 within the reactor 12 increases to a certain level, operation of the arc will be affected. Likewise, in examples where the feedstock 22 is used motor oil, as the concentration of fine-grain particles of metal in used motor oil increases, so does the conductivity of the feedstock 22.

As the conductivity of the feedstock 22 within the reactor 12 increases, operation of the arc is affected. In some embodiments, the load of the arc on the power supply 10 is measured, which will correlate the conductivity of the feedstock 22 being pumped through the plasma 18 as well as the distance between the electrodes 14/16. In some embodiments, a conductivity sensor 44 provides a signal to the control system 40, informing the control system 40 of the present conductivity of the feedstock 22. When the control system 40 finds the conductivity to be too high, the control system 40 either changes position of the electrodes 14/16 and/or initiates operation of the feedstock replenishment pump 62 for a specific period of time to further dilute the feedstock 22 within the reactor 12 with fresh feedstock 22. In some embodiments, the feedstock replenishment pump 62 is operated for a specific period of time or until the measured conductivity lowers to a predetermined level. It is anticipated that various level and pressure sensors are used to make sure that the reactor 12 is not overfilled, etc.

Referring now to FIG. 4, instead of a replenishment pump 62 and a source of new feedstock 23, a secondary material tank 70 and secondary material pump 72 is used. In this, the circulation pump 50, the power supply 10, the secondary material pump 72, and/or the electrodes 14/16 are controlled by the control system 40. Again, the control system 40 monitors the performance of the arc, controlling the voltage applied to the arc by the power supply 10, moving the anode 14 and/or cathode 16 closer to each other or farther away from each other to adjust the resulting plasma 18, cycling the electrodes 14/16 as one or both electrodes erode due to the arc, and adjusts the speed of the circulation pump 50 and, therefore, flow rate through the plasma 18. The control system 40 also controls the secondary material pump 72, signaling the secondary material pump 72 to pump a quantity of a secondary material 25 from a replenishment tank 70 containing this secondary material 25. Any secondary material 25 is anticipated. Examples of secondary materials include, but are not limited to, distilled water, tap water, petroleum-based solvents, alcohol, turpentine, etc.

As some types of feedstock 22 are transformed into the gas 24, the remaining feedstock 22 becomes more viscous, especially when impurities are suspended in the feedstock. One example of such is used motor oil, as the oil content is converted to gas 24 by the plasma 18 of the arc, the remaining feedstock 22 (oil) becomes more concentrated with, for example, suspending fine-grain metal particles. As the viscosity of the feedstock 22 increases, it takes more work for the circulation pump 50 to maintain the same flow rate through the plasma 18. In some embodiments, the load of the circulation pump motor is measured, which will correlate the viscosity of the feedstock 22 being pumped. In some embodiments, a viscosity sensor 42 provides a signal to the control system 40, informing the control system 40 of the current viscosity of the feedstock 22. When the control system 40 finds the viscosity to be too high, the control system 40 either adjusts the speed of the circulation pump 50 to compensate for the high viscosity or initiates operation of the secondary material pump 72 for a specific period of time to further dilute the feedstock 22 within the reactor 12 with the secondary material 25 from the secondary material tank 70. In some systems the control system 40 does both, adjusting the pump speed to compensate for the high viscosity and initiating operation of the secondary material pump 72 to insert a certain amount of the secondary material 25. In some embodiments, the secondary material pump 72 is operated for a specific period of time or until the measured viscosity lowers to a predetermined level. It is anticipated that various level and pressure sensors are used to make sure that the reactor 12 is not overfilled, etc. In the example with used motor oil as a feedstock 22, a secondary material 25 such as a solvent will dilute the used motor oil, either reducing the viscosity of the used motor oil, reducing the conductance of the used motor oil, or both.

It is also anticipated that, at some point in the operation, the measured viscosity exceeds a pre-determined level and the control system 40 indicates such to an operator for stopping, cleaning, and/or refilling the system.

As some types of feedstock 22 are transformed into the gas 24, the conductivity of these feedstocks changes due to certain dissolved or suspended materials concentrating in the remaining feedstock. One example of such is water containing salts. It is known that pure water does not conduct electricity (e.g. distilled water), but as salts are added to this pure water, water with suspended salts now conducts electricity. If the concentration of salts in the feedstock 22 within the reactor 12 increases to a certain level, operation of the arc will be affected.

As the conductivity of the feedstock 22 within the reactor 12 increases, operation of the arc is affected. In some embodiments, the load of the arc on the power supply 10 is measured, which will correlate the conductivity of the feedstock 22 being pumped through the plasma 18 as well as the distance between the electrodes 14/16. In some embodiments, a conductivity sensor 44 provides a signal to the control system 40, informing the control system 40 of the present conductivity of the feedstock 22. When the control system 40 finds the conductivity to be too high, the control system 40 either changes position of the electrodes 14/16 and/or initiates operation of the secondary material pump 72 for a specific period of time to further dilute the feedstock 22 within the reactor 12 with the secondary material 25. In some embodiments, the secondary material pump 72 is operated for a specific period of time or until the measured conductivity lowers to a predetermined level. In the example of a feedstock 22 of salts dissolved in water, as the water molecules are converted into the gas 24, the salt content of the remaining feedstock 22 increases, as does the viscosity and/or conductivity of the remaining feedstock 22. In this example, when the control system 40 determines that the viscosity and/or conductivity exceeds a predetermined threshold, the secondary material pump 72 is activated for a period of time or until the viscosity and/or conductivity decrease to a lower predetermined threshold. In this example, the secondary material 25 is, for example, distilled water or pure water with lower amounts of salts (e.g. tap water).

It is anticipated that various level and pressure sensors are used to make sure that the reactor 12 is not overfilled, etc. It is also anticipated that, in some embodiments, any combination of pumps 62/72 are present with any combination of additional feedstock 23 and one or more secondary material(s) 25. For example, in one embodiment, a replenishment pump 62 adds more new feedstock 23 (e.g. raw sewerage) and a secondary material pump 72 adds more secondary material 25 (e.g. fresh water). In another example, one secondary material pump 72 adds more of a first secondary material (e.g. fresh water) and another secondary material pump 72 adds more of a different secondary material (e.g. distilled water). Any number and combination of pumps 62/72, new feedstock tanks 60, and secondary material tanks 70 are anticipated. It is also anticipated that, for certain sources of new feedstock 23 and secondary material 25, the new feedstock 23 and/or secondary material 25 are not stored in tanks 60/70 and, instead, are fed directly from sources of such materials, for example, directly from sewerage lines, water lines, dredge systems, ocean water pumps, etc.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for producing a gas, the system comprising:
a reactor containing in its interior a feedstock and a set of electrodes;
a controller, the controller having means for controlling the electrodes, operatively forming an electric arc between the electrodes;
means for passing the feedstock through a plasma of the electric arc thereby converting at least some of the feedstock into a gas;
means for collecting the gas; and
means for introducing additional feedstock into the reactor, under control of the controller.

2. The system for producing the gas of claim 1, further comprising means for controlling temperature of the feedstock by the controller.

3. The system for producing the gas of claim 1, further comprising means for controlling pressure within the reactor by the controller.

4. The system for producing the gas of claim 1, further comprising means for determining the viscosity of the feedstock within the reactor by the controller and responsive to the viscosity exceeding a predetermined level, means for injecting a material into the reactor under control of the controller.

5. The system for producing the gas of claim 4, wherein the material is fresh feedstock.

6. The system for producing the gas of claim 4, wherein the material is a solvent.

7. The system for producing the gas of claim 4, wherein the material is tap water.

8. The system for producing the gas of claim 4, wherein the material is distilled water.

9. The system for producing the gas of claim 1, wherein the means for controlling the electrodes includes controlling of a voltage potential between the electrodes.

10. The system for producing the gas of claim 1, wherein the means for controlling the electrodes includes controlling a frequency of a voltage potential between the electrodes.

11. The system for producing the gas of claim 1, wherein the means for controlling the at least one set of electrodes includes controlling of a distance between the electrodes.

12. A system for producing a gas, the system comprising:
a reactor containing in its interior a feedstock and a pair of electrodes;
a computer, the computer operatively interfaced to a power supply, the power supply providing power to the electrodes;
software stored in a non-transitory storage that is accessed by the computer, the software running on the computer accepts operator control commands and responsive to the operator control commands, the software instructs the computer to control the power supply and form an electric arc between electrodes;
the software controls a pump to flow the feedstock through a plasma of the electric arc, the electric arc thereby converting at least some of the feedstock into a gas;
means for collecting the gas; and
the software reading a level sensor, the level sensor interfaced to the reactor and when the level sensor indicates a feedstock level is low, the software initiates flow of additional feedstock into the reactor by way of controlling a second pump.

13. The system for producing the gas of claim 12, further comprising means for measuring a temperature of the feedstock interfaced to the computer.

14. The system for producing the gas of claim 12, further comprising a pressure sensor interfaced to the reactor, providing a reading of a temperature of the reactor to the computer.

15. The system for producing the gas of claim 12, further comprising a sensor for reading a viscosity of the feedstock within the reactor interfaced to the computer; responsive to the viscosity exceeding a predetermined level, the software initiating operation of a third pump to inject a material into the reactor.

16. The system for producing the gas of claim 15, wherein the material is selected from the group consisting of fresh feedstock, a solvent, tap water, and distilled water.

17. The system for producing the gas of claim 12, wherein the software controls the power supply to set a voltage potential between the electrodes.

18. The system for producing the gas of claim 12, wherein the software controls the power supply to set a frequency of a voltage potential between the electrodes.

19. The system for producing the gas of claim 12, wherein the software controls a distance between the electrodes.

20. A system for producing a gas, the system comprising:
a reactor containing in its interior a feedstock and a set of electrodes;
a computer, the computer electrically interfaced to the set of electrodes;
software stored in a non-transitory storage that is accessed by the computer, the software accepts operator control commands and responsive to the operator control commands, the software instructs the computer to operatively form an arc between electrodes of the set of electrodes;
the software controls a pump to flow the feedstock through a plasma of the arc, the arc thereby converting at least some of the feedstock into a gas;
means for collecting the gas; and
the software reading a viscosity of the feedstock through a sensor that is interfaced to the reactor and to the computer, the software initiates operation of a second pump to inject a material into the reactor responsive to the software determining that the viscosity of the feedstock is greater than a pre-determined viscosity;
whereas the material is selected from the group consisting of additional feedstock, a solvent, tap water, and distilled water.
